(19) United States
(12) Patent Application Publication
(10) Pub. No.: US 2010/0181493 A1
(43) Pub. Date: Jul. 22, 2010

(54) IONIC EMISSION MICRONIC SOURCE

(76) Inventors: Pierre Sudraud, Puyloubier (FR); Olivier Salord, Trets (FR); Arnaud Houel, Aubagne (FR)

Correspondence Address: SUGHRUE MION, PLLC, 2100 PENNSYLVANIA AVENUE, N.W., SUITE 800, WASHINGTON, DC, 20037, US

(21) Appl. No.: 12/668,228

(22) PCT Filed: Jul. 8, 2008
(86) PCT No.: PCT/FR08/00989

§ 371 Date: Mar. 17, 2010

(30) Foreign Application Priority Data
Jul. 9, 2007 (FR) 0704939

(51) Int. Cl. H01J 27/02; H01J 3/14

(52) U.S. Cl. 250/396 R; 250/424; 250/423 R

(57) ABSTRACT

The present invention relates to an ion emitter device comprising an emitter member including an insulating hollow needle (10), the hollow needle presents an electrically insulating point (16) that projects from its apex (13). In addition, the needle (10) includes a cavity (11) that presents an escape orifice (14) that opens out in the vicinity of the point (16). The invention also provides a focused ion emission method using the above emitter device and an extractor electrode, the method comprising applying an extraction voltage to the extractor electrode. In addition, when the device has a regulator electrode, the method comprises applying a regulation voltage to said electrode.

The present invention relates to an ion emitter source of micrometer size.

The field of the invention is that of emitting focused ions from point or quasi-point source. The material for ionizing is supplied to the source in the liquid phase in the form of pure elements or compounds, often including metallic elements.

Industrial applications of liquid metal ion sources (LMISs) are presently dominated by focused ion beam (FIB) technology. That technology enables an ion probe to be produced of submicrometer size that offers a current density of several amps per square centimeter (A/cm²). It is used in particular in microelectronics for various tasks:
analyzing integrated circuit failures;
modifying or reconfiguring devices that present submicrometer dimensions such as integrated circuits or the masks used in photolithography;
making devices directly by etching or by assisted deposition; and
analyzing chemical composition by mass spectrometry of secondary ions.

Certain sources are capable of offering a lifetime that is relatively long (greater than 1000 microamp-hours (μA.h)), however those apply solely to materials that present a low saturating vapor pressure at their melting temperatures. Such materials are thus limited to a few metals and a few metal alloys, and gallium constitutes the preferred metal.

Thus, the article “Characteristics of a gallium liquid metal field emission ion source” J. Phys. D: Appl. Phys., 13 (1980), pp. 1747-1755 describes an ion source designed to ionize that metal. The ion source comprises an emitter member arranged under an extractor member in the form of a disk-shaped electrode that is pierced at its center. The emitter member is in the form of a reservoir having the apex of a tungsten point placed within the reservoir projecting from its top. The point is made of metal since the ionization field is obtained by applying a relatively high electrical voltage (lying in the range 4 kilovolts (kV) to 10 kV) between the point and the disk-shaped electrode.

It is also appropriate to reconsider the technique of analysis by secondary ion mass spectrometry (SIMS) which constitutes an important application of LMIS sources.

The drawback of elements such as gallium is the lack of chemical reactivity between the species of the primary beam that is formed and the pulverized sample (ion bombardment).

Although gallium makes it possible to obtain very good dimensional resolution (of the order of ten nanometers), its emission yield of secondary ions is low, thereby reducing the possibility of using it for quantitative analyses. In contrast, more conventional analysis systems using reactive species for obtaining a high yield of secondary ions suffer from poor dimensional resolution.

In particular, cesium (Cs), which is one of the most chemically reactive metals, increases the emission yield of negative secondary ions considerably. Industrial SIMS systems use such conventional Cs sources (generally of the surface ionization type), but the brightness of such ion sources is low and therefore cannot be compared with that of gallium LMIS sources.

In addition, the violent reactivity of cesium makes it difficult to handle. As a result, all attempts at making cesium SIMS sources has been restricted to research laboratories, since they have no achieved a level of reliability that is sufficient for industrial applications.

It is thus not possible to benefit from phenomena that occur during the non-focused reactive ion bombardment that is used, in particular in reactive ion etching. This low chemical reactivity limits the pulverization and ionization rates of various targets. As an indication, the pulverization rate lies in the range 1 to 4 pulverized atoms per incident ion for an acceleration voltage of the order of 30 kV. The lack of gaseous recombination at the point of beam impact prevents the pulverized atoms being removed effectively. That often leads to redeposition in the vicinity of the point of impact, and that lies at the origin of numerous difficulties. Firstly, when the pulverized atoms are electrically conductive, unwanted connections may appear on the target. Secondly, the relatively low form factor (of the order of 6/1) as a result of redeposition severely restricts the resolution of etched patterns.

To summarize, sources are available firstly with low secondary ion yield and high dimensional resolution, and secondly with high secondary ion yields but low dimensional resolution.

An attempt at solving the problems associated with the chemical reactivity of alkali metals is described in the article “Lithium ion emission from a liquid metal source of LiNO₃”, by A. E. Bell et al., International Journal of Mass Spectrometry and Ion Processes, 88 (1989), pp. 56-68. That article recounts experiments with ion sources similar to LIMS sources. The metals were replaced by chemical compounds containing those metals. In particular, a beam of Li⁺ ions was produced with a source using a liquid salt, specifically lithium nitrate (LiNO₃). The source was a metal needle covered in the molten salt. The experiments revealed that bubbles of gas were generated at the needle and the molten salts evaporated very quickly. The energy of the emitted ions, as measured by means of a retarding potential analyzer, presents an energy dispersion of 110 electron volts (eV) at the mid-height width. That dispersion is thought to be due to the contributions of the field ionization of the gaseous phase and of the field desorption at the apex of the point. Ion sources with an energy dispersion that is so wide are unsuitable for use in industrial systems, since ion beam focusing is considerably limited by chromatic aberrations.

Those sources have lifetimes that are very short. The metal point is subjected to the electroerosion phenomenon. In addition, the speed of evaporation from the reservoir is very high because of the high saturating vapor pressure of the salt heated to the liquid state.

Various other known sources make use of an electrically conductive point as the emitter member.

Thus, document U.S. Pat. No. 4,488,045 describes an ion source that includes a reservoir. The reservoir presents a point that projects at the apex. It includes a cavity presenting an escape orifice (the end of the capillary) that opens out in the vicinity of the point. The point is electrically conductive. An extraction voltage is applied between the point and an extractor electrode.

Document JP 59 054156 discloses an electrode structure for an ion beam generator of the field effect emission type. The electrode is conductive.

Document EP 0 706 199 significantly improves the situation by proposing a source that is provided with an insulating refractory ceramic needle, thereby eliminating the electrode erosion phenomenon. Nevertheless, that improvement is not sufficient for obtaining a lifetime that is compatible with industrial constraints, since the problem of the speed of evaporation that remains unsolved puts limits both on the lifetime and on the compositions that can be used with that kind of point.

A first object of the present invention is to thus to provide a micrometer-sized ion emission source that presents a lifetime that is considerably extended and that enables a very wide variety of active or inactive compositions to be used.

According to the invention, the ion emitter device comprises an emitter member that includes a hollow needle, the needle presenting an insulating point that projects at the apex; furthermore, the needle includes a cavity presenting an escape orifice that opens out in the vicinity of the point.

Thus, the composition that is to be ionized appears in the cavity, thereby securing several advantages. Firstly, this arrangement limits the evaporation of the composition considerably. That gives rise to a significant increase in the lifetime of the source. Furthermore, it becomes possible to include, in the composition, elements that present high saturating vapor tension at their melting points. Secondly, using a cavity for storing the composition makes it possible to employ elements that are highly reactive, in particular solutions that are liquid at room temperature such as acids, bases, or dissolved salts.

Furthermore, it is preferable for the needle also to be electrically insulating.

The invention presents its best performance when the sensitive elements present dimensions of micrometer or submicrometer size.

Thus, it is desirable for the area of the exchange section between the cavity and the outside of the needle to be less than 100 square micrometers (μm²).

Similarly, the greatest dimension of the point (usually its diameter) is preferably less than 50 micrometers (μm).

In a first embodiment, the point is disposed in the cavity, in a configuration where it is coaxial with the needle.

In a second embodiment, the point is secured to the apex of the needle.

Nevertheless, when the needle is of small size, the volume of the composition that can be stored in the needle is very small.

Thus, the emitter member preferably has a support added thereto with the base of the hollow needle being fastened therein.

The support includes a reservoir that communicates with the feed orifices presented by the cavity. This feed orifices leads to the base of the needle.

In order to encourage the emission of certain compositions, the device advantageously includes means for heating the needle.

Similarly, it includes means for heating the support.

As in the prior art, it further includes a pierced extractor electrode that is mechanically connected to the needle.

A second object of the present invention is to increased the uniformity with which the needle is heated.

Thus, according to an additional characteristic, the device includes a cylindrical metal sleeve that is mechanically connected to the needle.

Furthermore, sources of this type are frequently associated with fluctuations in emission current.

A third object of the present invention is to enable the emission current to be adjusted finely with high-performance regulation of the current.

Thus, a first electrically conductive electrode that is insulated from the needle acts as a regulator electrode, and the device includes a power supply for applying a voltage to said plate.

In order to increase the versatility of the device, the needle is made of a refractory insulating material.

The invention also provides a method of focused ion emission making use of a device including an emitter needle and an extractor electrode, said needle presenting an electrically insulating emitter point that projects from its apex and being associated with an extractor electrode, the needle further including a cavity that presents an escape orifice opening out in the vicinity of the point, which method comprises applying an extraction voltage to the extractor electrode; in addition the device includes a regulator electrode and the method comprises applying a regulation voltage to the regulator electrode.

A major benefit of the present invention is that it provides novel point sources of ions than are very bright and that present a long lifetime, while using liquid ion compounds made up of mixtures, e.g. mixtures of molten salts, acids, and bases, but not limited thereto.

Another benefit of the present invention is that it provides novel point sources of ions that are very bright and that present a long lifetime, making it possible to have recourse to compounds with high vapor pressures at their melting temperatures.

Another benefit of the present invention is that it provides novel point sources of ions that are very bright and that present a long lifetime, using liquid ion compounds that are adapted to producing a broad spectrum of ionic species with very high chemical reactivity, including alkali metals and halogens.

Another benefit of the present invention is that it provides novel point sources of ions that are very bright and that present a long lifetime, using liquid ion compounds that have preexisting ions for point emission of positive or negative ions.

Another additional benefit of the present invention is to be able to equip improved FIB systems that are adapted to such novel point sources of ions that are very bright and of long lifetime in order to produce novel beams of reactive ionic species with high resolution and using probes of submicrometer and nanometer sizes. Such systems are compatible with industrial applications.

The novel characteristics specific to the present invention are set out in the claims of the present invention. Nevertheless, the invention itself and other benefits, objects, and advantages that stem therefrom can be better understood on referring to the following detailed description of the preferred embodiments, to be read together with the accompanying drawings, in which:

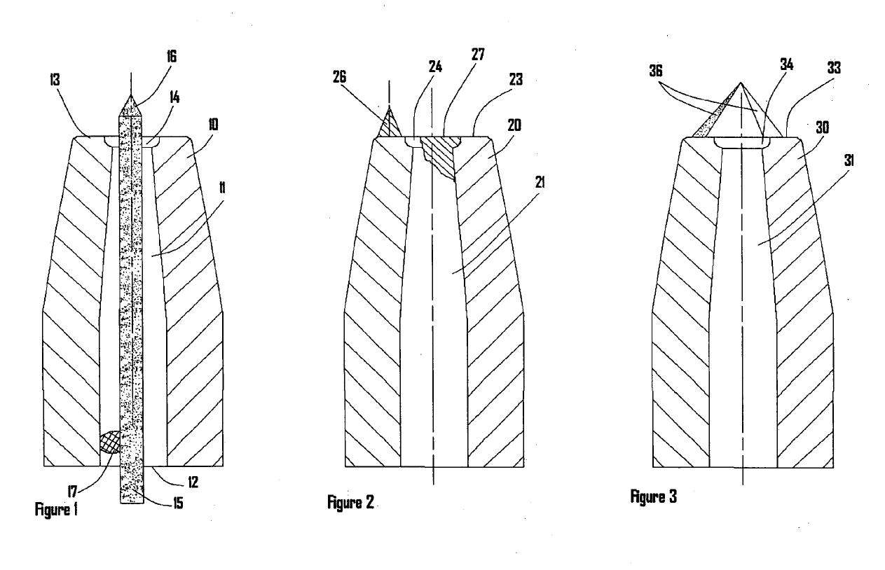

FIG. 1 is a section view of a first embodiment of a hollow needle;

FIG. 2 is a section view of a second embodiment of a hollow needle;

FIG. 3 shows a variant of the second embodiment;

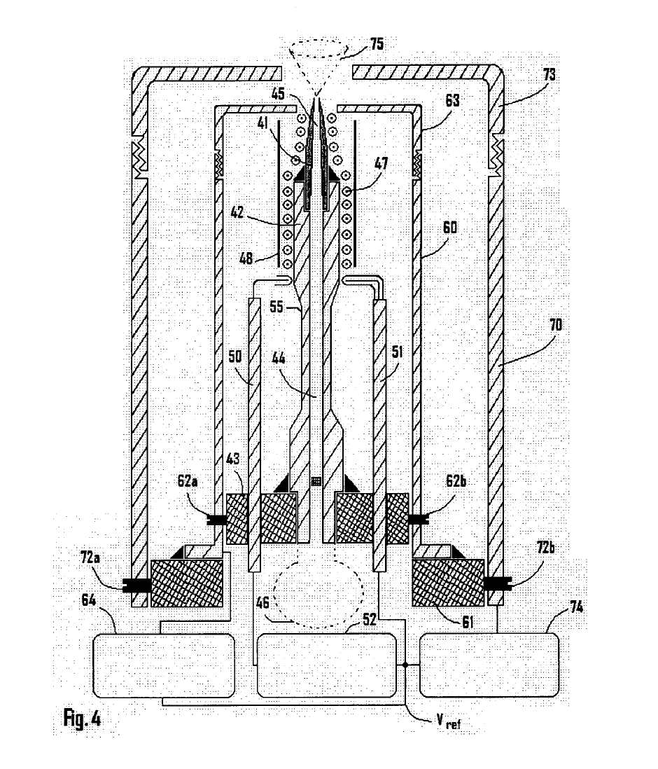

FIG. 4 is a diagrammatic section view of an ion emitter device;

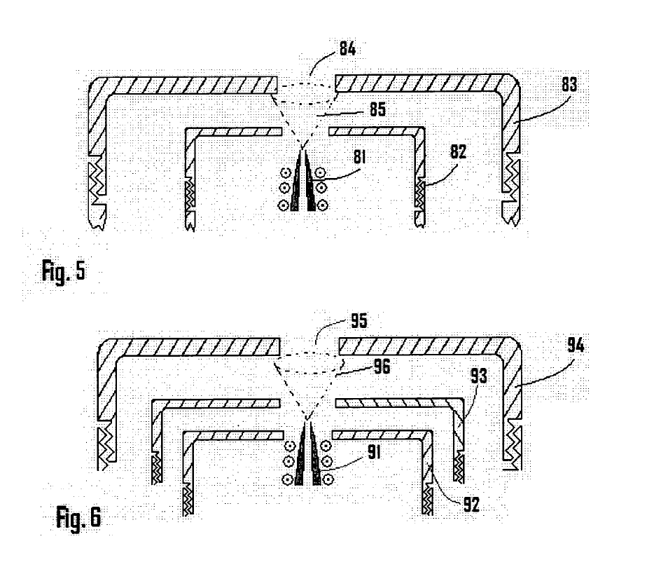

FIG. 5 is a fragmentary view of a variant of the device; and

FIG. 6 is a fragmentary view of a second variant of the device.

In a first embodiment, and with reference to FIG. 1, a hollow needle 10 is in the form of a capillary, the internal duct of the capillary constituting a cavity 11 for receiving the composition that is subjected to ionization. The capillary is analogous to the crucibles used in microelectronics for ultrasound or thermo-compression cabling. It is preferably electrically insulating.

The base 12 of the needle 10 (at the bottom of the figure) is shown as being open, however it could be closed if the volume of the cavity 11 is found to be large enough to store the required quantity of composition.

The cavity 11 is open at the apex of the needle 10 via a circular escape orifice 14 of diameter that is smaller than a few tens of micrometers.

A cylindrical rod 15 of insulating refractory material and of diameter smaller than that of the escape orifice is arranged inside the cavity 11. Its apex end forms a point 16 that projects from the apex 13 of the needle 10. Any suitable means, e.g. a drop of adhesive 17, hold the rod in position so that its axis coincides substantially with the axis of the needle 10. The diameter of the cylindrical rod 15 also enables the escape orifice 14 to be partially closed by providing an exchange section between the cavity and the outside that is of micrometer or submicrometer size, so as to limit evaporation in the vicinity of the point 16. The area of the exchange section is preferably less than 100 μm².

The function of the point 16 is to stabilize the Taylor cone, well known to the person skilled in the art, which cone has a half-angle of inclination relative to its axis that theoretically has the value 49.3°. The point is thus machined so that it likewise forms a cone presenting a half-angle of inclination that is preferably less than or equal to 60°.

A preferred technique for machining the point 16 is etching assisted by a focused beam of ions. This technique enables the apex end of the alumina rod 15 to be shaped so as to define the point 16 of micrometer or submicrometer size (height less than 10 micrometers (μm)) with a high degree of dimensional resolution, of the order of a few nanometers.

With reference to FIG. 2, there can be seen a second embodiment of a point at the apex of a hollow needle. The body of the needle 20 is the same as in the preceding embodiment, such that it too presents a cavity 21 that opens out at its apex 23 via an escape orifice 24.

A point 26 is shaped on the apex 23 of the needle. This operation is preferably performed by a deposition technique assisted by a focused beam of ions or electrons, the deposition being chemical vapor deposition (CVD), for example.

This technique also serves to partially obtain partial closure 27 of the escape orifice 24 so as to form an exchange section between the cavity and the outside that is of micrometer or submicrometer size, for the purpose of limiting evaporation in the vicinity of the point 26. The area of the exchange section is preferably less than 100 μm².

With reference to FIG. 3, a variant of the preceding embodiment is shown in detail. Once more, the needle 30 has an internal cavity 31 that opens out at its apex 33 via an escape orifice 34. The point 36 in this variant is in the form of a tripod standing on the apex 33 of the needle. It is likewise formed by CVD assisted by a focused beam of ions or electronics.

The cavities in the above needles are of small volume, which volume is often insufficient for most applications.

Thus, within an emitter member, provision is made for an additional reservoir to increase the quantity of composition that is stored.

With reference to FIG. 4, the needle 41 (shown without its point) is engaged in leaktight manner in a metal support 42, itself fastened on a stand 43 of insulating material. The support 42 includes a reservoir 44 that communicates with the base of the needle 41, the base thus acting as an admission orifice to the cavity 45 in the needle.

When the cavity of the reservoir 44 is sufficient, it is itself closed approximately level with the stand 43. However, if the combined volume of the cavity 45 and of the reservoir 44 is still insufficient, provision is made for an additional reservoir 46 represented by a dashed-line circle in the figure. The means for connecting the two reservoirs 44 and 46 together are not shown in detail since they form part of the general knowledge of the person skilled in the art.

When the composition for ionizing is not liquid at ambient temperature, a heater element 47 such as a coaxial heater cable is wound helically around the portion of the needle 41 that projects from the support 42. This heater cable 47 is optionally extended over the apex portion of the support 42. A cylindrical sleeve 48 surrounds all or part of the cable 47. The function of the sleeve is firstly to make the heating uniform, and secondly to act as a thermal shield relative to radiation emitted by the hot source, i.e. the needle 41 and the support 42.

The heater cable 47 comprises a resistive core coated in an insulator, the insulator itself being held captive in a conductive outer sheath. At one end, the core of the cable is connected to a first feedthrough 50, and at its other end, the core and the outer sheath are connected to a second feedthrough 51. Thus, the potential of the sheath is set at the reference potential Vref. The two feedthroughs 50, 51 are also connected to a heater power supply 52.

The support 42 presents a constriction 55 beneath the heater cable 47, such that its base portion is at a temperature that is relatively low, thereby enabling a powder to be conserved in the solid state.

In addition to the above-described emitter member, the device also has an extractor member.

The ion extractor member comprises a second cylindrical tube 70 fastened to the plate 61. The second tube 70 is provided with a centering screw 72a, 72b that bears against the plate 62 so that its axis can be accurately positioned relative to the axis of the support 42 and of the needle 41.

A second electrode 73 closes the second tube 70, except insofar as it is pierced in its center in order to release the ion emission cone 75. It is secured to said tube in such a manner as to be capable of being subjected to axial movement in translation of small amplitude. By way of example, this is done by providing complementary threads at the corresponding ends of the second tube 70 and of the second electrode 73.

The second tube 70 is connected to an extractor electrical power supply 74 that its designed to apply a positive or negative potential thereto relative to the reference potential Vref. This makes it possible to emit ions that are negative or positive.

In addition to the above-described emitter member and extractor member, the device also includes a regulator member. This member comprises a first cylindrical tube 60 fastened to a plate 61. The first tube 60 is provided with a centering screw 62a, 62b that bears against the stand 43 so that it is possible to position its axis accurately relative to the axis of the support 42 and of the needle 41.

An electrode 63 closes the first tube 60, except insofar as it is pierced at its center so as to leave the apex of the needle 41 free. It is secured to said tube in such a manner as to be capable of being subjected to movement in axial translation of limited amplitude. By way of example, this is done by providing complementary threads at the corresponding ends of the first tube 60 and of the first electrode 63.

The regulator member acts mainly as a thermal screen.

It may also act as an electrostatic regulator electrode. For this purpose, it is connected to a regulator electrical power supply 64 that is designed to apply a positive or negative potential thereto lying in the range 0 to 2000 volts (V) relative to the reference potential Vref.

For more details, reference may be made to the above-mentioned document EP 0 706 199.

With reference to FIG. 5, a variant of the device is shown in which the apex of the needle 81 is held set back a little from the first electrode or extractor electrode 82, and in which the second electrode 83 is placed above said electrode, with its central opening constituting an acceptance diaphragm 84.

Under such circumstances, the power supply to the second electrode 83 delivers a positive or negative voltage lying in the range 300 V to 1000 V relative to the potential of the first extractor electrode 82. This voltage enables secondary particles emitted against the acceptance diaphragm 84 by a portion of the cone 85 to be eliminated.

With reference to FIG. 6, a second variant of the device is shown, in which a third electrode is added to the configuration shown in FIG. 4.

The apex of the needle 91 is now in front of the first electrode or regulator electrode 92. The second electrode or extractor electrode 93 is placed above the electrode 92, and the third electrode or suppressor electrode 94 is placed above the electrode 93. The central opening in the electrode 94 constitutes an acceptance diaphragm 95.

The first electrode 92 is connected to the regulator electrical power supply 64 that serves to apply a positive or negative potential thereto lying in the range 0 to 2000 V relative to the reference potential Vref.

The second electrode 93 is connected to an extractor electrical power supply 74 that is designed to apply a positive or negative potential thereto relative to the reference potential Vref. It is thus possible to emit either negative ions or positive ions.

The third electrode 94 is connected to an additional electrical power supply (not shown in FIGS. 4 and 6) that, in this example, delivers a positive or negative voltage lying in the range 300 V to 1000 V. This voltage serves to eliminate secondary particles emitted against the acceptance diaphragm 95 by a portion of the cone 96.

The above-described device is suitable for implementing a focused ion emission method, the device comprising an emitter needle, an extractor electrode, and a regulator electrode. It is applicable regardless of whether the needle does or does not include an additional reservoir, even though if it does not include an additional reservoir the device does not benefit from some of the advantages mentioned above.

The method consists essentially in applying an extractor voltage to the extractor electrode and a regulator voltage to the regulator electrode.

It is particularly suitable for liquid compositions presenting a wide range of saturating vapor pressures at their melting temperatures, compositions that may include acids, bases, and mixtures of ionic compounds such as dissolved salts.

Finally, it is specified that the present invention enables protons to be emitted with very good brightness, which is practically impossible to achieve with a conventional LMIS source. Numerous applications, in particular in microanalysis are concerned:
proton microscopy;
ionic lithography (no proximity effect for high sensitivity resins);
localized Rutherford back-scattering (RBS) analysis; and
analysis of X-rays induced by proton induced X-ray emission (FIXE).

The embodiments of the invention described above are selected for their concrete nature. Nevertheless, it is not possible to list exhaustively all embodiments covered by the invention. In particular, any step or any means described above may be replaced by an equivalent step or equivalent means without going beyond the ambit of the present invention.

1. An ion emitter device comprising an emitter member that includes a needle (10, 20, 30, 41, 81, 91), the needle presenting an electrically insulating point (16, 26, 36) that projects from the apex (13, 23, 33) of the needle, the device being characterized in that said needle (10, 20, 30, 41, 81, 91) includes a cavity (11, 21, 31, 45) presenting an escape orifice (14, 24, 34) that opens out in the vicinity of said point (16, 26, 36).

2. A device according to claim 1, characterized in that said needle (10, 20, 30, 41, 81, 91) is electrically insulating.

3. A device according to claim 1, characterized in that the area of the exchange section between said cavity (11, 21, 31, 45) and the outside of said needle (10, 20, 30, 41, 81, 91) is less than 100 μm2.

4. A device according to claim 1, characterized in that the largest dimension of said point (16, 26, 36) is less than 50 μm.

5. A device according to claim 1, characterized in that said point (15, 16) is disposed inside said cavity (11).

6. A device according to claim 1, characterized in that said point (26, 36) is secured to the apex (23, 33) of the needle (20, 30).

7. A device according to claim 1 characterized in that said emitter member includes a support (42) in which the base of said needle (41) is fastened, said cavity (45) presenting a feed orifice that opens out into the base of said needle (41), said support (42) including a reservoir (44, 46) that communicates with said feed orifice.

8. A device according to claim 7, characterized in that it includes a closed reservoir (46) communicating with said feed orifice.

9. A device according to claim 1, characterized in that it includes heater means (47) for heating said needle (41).

10. A device according to claim 7, characterized in that it includes heater means (47) for heating said support (42).

11. A device according to claim 1, characterized in that it further comprises a pierced extractor electrode (73, 82, 93) that its mechanically centered relative to said needle (41, 81, 91).

12. A device according to claim 1, characterized in that comprises a pierced regulator electrode (63, 92) that is mechanically centered relative to said needle (41, 91).

13. A device according to claim 1, characterized in that it comprises a pierced suppressor electrode (83, 94) that is mechanically centered relative to said needle (81, 91), said electrode (83, 94) collecting the secondary particles emitted by the portion of the cone (85, 96) that interacts with said suppressor electrode (83, 94).

14. A device according to claim 1, comprising an emitter member that includes a needle (10, 20, 30, 41, 81, 91), said needle presenting a point (16, 26, 36), the device being characterized in that said needle (10, 20, 30, 41, 81, 91) and said point (16, 26, 36) are made of a refractory material.

15. A focused ion emission method using a device including a needle (10, 20, 30, 41, 81, 91), the needle presenting an electrically insulating emitter point (16, 26, 36) projecting from its apex and associated with an extractor electrode (73, 93), said needle (10, 20, 30, 41, 81, 91) including a cavity (11, 21, 31, 45) presents an escape orifice (14, 24, 34) that opens out in the vicinity of said point (16, 26, 36), the method comprising applying an extraction voltage to the extractor electrode (82, 93), and being characterized in that, for the device further including a suppressor electrode (83, 94), the method comprises applying a suppression voltage to the suppressor electrode (83, 94).

16. A focused ion emission method using a device including a needle (10, 20, 30, 41, 81, 91), the needle presenting an electrically insulating emitter point (16, 26, 36) that projects from its apex and being associated with an extractor electrode (93), said needle (10, 20, 30, 41, 81, 91) including a cavity (11, 21, 31, 45) that presents an escape orifice (14, 24, 34) opening out in the vicinity of said point (16, 26, 36), the method comprising applying an extraction voltage to the extractor electrode (93), and being characterized in that, for the device further including a suppressor electrode (94) and a regulator electrode (92), the method comprises applying a suppression voltage to said suppressor electrode (94) and applying a regulation voltage to said regulator electrode (92).
